(19) United States
(12) Patent Application Publication
(10) Pub. No.: US 2023/0163314 A1
(43) Pub. Date: May 25, 2023

(54) GAS DIFFUSION LAYERS WITH ENGINEERED SURFACE ROUGHNESS FOR HOSTING CATALYSTS

(71) Applicant: The Board of Trustees of the Leland Stanford Junior University, Palo Alto, CA (US)

(72) Inventors: Shicheng XU, Stanford, CA (US); Friedrich B. PRINZ, Stanford, CA (US)

(73) Assignee: The Board of Trustees of the Leland Stanford Junior University, Palo Alto, CA (US)

(21) Appl. No.: 17/916,553

(22) PCT Filed: Mar. 31, 2021
(86) PCT No.: PCT/US2021/025199

§ 371 Date: Sep. 30, 2022

Related U.S. Application Data
(60) Provisional application No. 63/005,050, filed on Apr. 3, 2020.

(51) Int. Cl. H01M 4/86; H01M 8/1004; H01M 8/1018

(52) U.S. Cl. CPC H01M 4/8605; H01M 8/1004; H01M 8/1018; H01M 2008/1095

(57) ABSTRACT

Disclosed herein are gas diffusion layers (GDLs) for electrochemical devices which have increased surface area for hosting catalysts or contacting a catalyst layer. GDLs with engineered surface roughness increase the effective diffusivities of gas phase reactants in electrochemical devices (e.g., PEMFCs). Also disclosed herein are gas diffusion electrodes, membrane electrode assemblies, and fuel cells comprising GDLs with increased surface area. Also disclosed herein are methods of manufacturing GDLs with increased surface area, as well as gas diffusion electrodes and membrane electrode assemblies comprising GDLs with increased surface area.

### CROSS-REFERENCE TO RELATED APPLICATIONS

This application claims priority under 35 U.S.C. § 119(e) to U.S. Provisional Application No. 63/005,050, filed Apr. 3, 2020, which is hereby incorporated by reference in its entirety.

### BACKGROUND

For electrochemical devices that use gases as reactants or products, the diffusivity of gas-phase reactants affects the utilization of catalysts and overall device performance, especially at high electric current density regions. For instance, FIG. 1 shows results from a multiphysics simulation comparing the catalyst utilization and J-V curves of a polymer electrolyte membrane fuel cell (“PEM fuel cell” or “PEMFC”) under different effective oxygen diffusivities (in units of m²/s). As shown in FIG. 1, an increase in the effective diffusivity enhances cell voltage under the same current density due to improved catalyst utilization.

Therefore, there exists a need for gas diffusion layers (“GDLs”), gas diffusion electrodes (“GDEs”), membrane electrode assemblies (“MEAs”), and electrochemical devices (e.g., fuel cells) containing the same, which are configured to increase the effective diffusivity of gas phase reactants, improve catalyst utilization, and thereby enhance overall device performance. Disclosed herein are GDLs for use in electrochemical devices which have increased surface area for hosting catalysts or contacting a catalyst layer. GDLs with engineered surface roughness can increase the effective diffusivities of gas phase reactants in electrochemical devices (e.g., PEMFCs). Also disclosed herein are gas diffusion electrodes, MEAs, and fuel cells comprising GDLs with increased surface area. Also disclosed herein are methods of manufacturing GDLs with increased surface area, as well as gas diffusion electrodes and MEAs comprising GDLs with increased surface area.

### SUMMARY

In one aspect, the present disclosure relates to a gas diffusion layer for an electrochemical device, comprising: (a) a first side in contact with a catalyst layer; and (b) a second side, wherein the first side in contact with the catalyst layer has increased surface area.

In some embodiments, the first side of the gas diffusion layer in contact with the catalyst layer comprises surface features that have an average depth of between about 10 nm and about 1000 μm. In some embodiments, the first side of the gas diffusion layer in contact with the catalyst layer comprises surface features, wherein the surface features have at least one lateral dimension between about 10 nm and about 1000 μm.

In some embodiments, the first side of the gas diffusion layer in contact with the catalyst layer comprises surface features that are regularly shaped. In some embodiments, the first side of the gas diffusion layer in contact with the catalyst layer comprises surface features that are irregularly shaped.

In some embodiments, the first side of the gas diffusion layer in contact with the catalyst layer comprises surface features that are randomly arranged. In some embodiments, the first side of the gas diffusion layer in contact with the catalyst layer comprises surface features that are periodically arranged.

In some embodiments, the gas diffusion layer further comprises a microporous layer, wherein the first side of the gas diffusion layer in contact with the catalyst layer is disposed on the microporous layer.

In another aspect, the present disclosure relates to a gas diffusion electrode, comprising: (a) a gas diffusion layer; and (b) a catalyst layer in contact with the gas diffusion layer at an interface between the gas diffusion layer and the catalyst layer, wherein the interface between the gas diffusion layer and the catalyst layer has an increased surface area.

In some embodiments, the interface between the gas diffusion layer and the catalyst layer comprises surface features that have an average depth of between about 10 nm and about 1000 μm. In some embodiments, the interface between the gas diffusion layer and the catalyst layer comprises surface features that have at least one lateral dimension between about 10 nm and about 1000 μm.

In some embodiments, the interface between the gas diffusion layer and the catalyst layer comprises surface features that are regularly shaped. In some embodiments, the interface between the gas diffusion layer and the catalyst layer comprises surface features that are irregularly shaped.

In some embodiments, the interface between the gas diffusion layer and the catalyst layer comprises surface features that are that are randomly arranged. In some embodiments, the interface between the gas diffusion layer and the catalyst layer comprises surface features that are periodically arranged.

In some embodiments, the gas diffusion layer further comprises a microporous layer, wherein the side of the gas diffusion layer in contact with the catalyst layer is disposed on the microporous layer.

In another aspect, the present disclosure relates to a membrane electrode assembly for a fuel cell, comprising: (a) a gas diffusion layer; (b) a polymer electrolyte membrane; and (c) a catalyst layer disposed between the gas diffusion layer and the polymer electrolyte membrane, wherein the gas diffusion layer comprises: (i) a first side in contact with the catalyst layer; and (ii) a second side, wherein the first side of the gas diffusion layer has increased surface area.

In some embodiments, the first side of the gas diffusion layer in contact with the catalyst layer comprises surface features having an average depth of between about 10 nm and about 1000 μm. In some embodiments, the first side of the gas diffusion layer in contact with the catalyst layer comprises surface features having at least one lateral dimension of between about 10 nm and about 1000 μm.

In some embodiments, the first side of the gas diffusion layer in contact with the catalyst layer comprises surface features that are regularly shaped. In some embodiments, the first side of the gas diffusion layer in contact with the catalyst layer comprises surface features that are irregularly shaped.

In some embodiments, the first side of the gas diffusion layer in contact with the catalyst layer comprises surface features that are randomly arranged. In some embodiments, the first side of the gas diffusion layer in contact with the catalyst layer comprises surface features that are periodically arranged.

In some embodiments, the gas diffusion layer comprises a microporous layer, wherein the first side of the gas diffusion layer in contact with the catalyst layer is disposed on the microporous layer.

In another aspect, the present disclosure relates to fuel cell comprising a membrane electrode assembly for a fuel cell, comprising: (a) a gas diffusion layer; (b) a polymer electrolyte membrane; and (c) a catalyst layer disposed between the gas diffusion layer and the polymer electrolyte membrane, wherein the gas diffusion layer comprises: (i) a first side in contact with the catalyst layer; and (ii) a second side, wherein the first side of the gas diffusion layer has increased surface area.

In some embodiments, the first side of the gas diffusion layer in contact with the catalyst layer comprises surface features having an average depth of between about 10 nm and about 1000 μm. In some embodiments, the first side of the gas diffusion layer in contact with the catalyst layer comprises surface features having at least one lateral dimension of between about 10 nm and about 1000 μm.

In some embodiments, the first side of the gas diffusion layer in contact with the catalyst layer comprises surface features that are regularly shaped. In some embodiments, the first side of the gas diffusion layer in contact with the catalyst layer comprises surface features that are irregularly shaped.

In some embodiments, the first side of the gas diffusion layer in contact with the catalyst layer comprises surface features that are randomly arranged. In some embodiments, the first side of the gas diffusion layer in contact with the catalyst layer comprises surface features that are periodically arranged.

In some embodiments, the gas diffusion layer comprises a microporous layer, wherein the first side of the gas diffusion layer in contact with the catalyst layer is disposed on the microporous layer.

In another aspect, the present disclosure relates to a fuel cell comprising: (a) a gas diffusion layer; (b) a polymer electrolyte membrane; and (c) a catalyst layer disposed between the gas diffusion layer and the polymer electrolyte membrane, wherein the gas diffusion layer has an increased surface area at a high electric current density region.

In another aspect, the present disclosure relates to a method of manufacturing a gas diffusion electrode for an electrochemical device, comprising: (a) providing a gas diffusion layer, wherein the gas diffusion layer comprises a first side having an increased surface area; and (b) contacting the first side of the gas diffusion layer with a catalyst layer. In some embodiments, the gas diffusion layer further comprises a gas transport layer and a macro-porous layer having a first side in contact with the gas transport layer and a second side; and the first side of the gas diffusion layer is the second side of the macro-porous layer.

In another aspect, the present disclosure relates to a method of manufacturing a membrane electrolyte assembly for an electrochemical device, comprising: (a) providing a gas diffusion layer, wherein the gas diffusion layer comprises a first side having an increased surface area; (b) contacting the first side of the gas diffusion layer with a catalyst layer, wherein the catalyst layer has a first side in contact with the gas diffusion layer and a second side; and (c) contacting the second side of the catalyst layer with a polymer electrolyte membrane. In some embodiments, the gas diffusion layer further comprises a gas transport layer and a macro-porous layer having a first side in contact with the gas transport layer and a second side; and the first side of the gas diffusion layer is the second side of the macro-porous layer.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

FIG. 1 shows simulated catalyst utilization (top) and simulated cell voltage (bottom) as a function of current density for different oxygen diffusivities

FIG. 2A shows a schematic illustration of a membrane electrode assembly including a polymer electrolyte membrane (“PEM”) and a gas diffusion electrode comprising a catalyst layer and a gas diffusion layer (“GDL”) (top). The GDL may further comprise a macro-porous layer and a gas transport layer (bottom).

FIG. 2B shows a general schematic illustration of a PEMFC assembly, including a cathode GDL, cathode catalyst layer, PEM, anode catalyst layer, and anode GDL.

FIG. 3A is a schematic illustration of a side-on cross-sectional view of a GDL with an unmodified surface (without engineered surface roughness).

FIG. 3B shows schematic illustrations (side-on cross-sectional views) of GDLs with engineered surface roughness, having regularly-shaped surface features.

FIG. 3C shows schematic illustrations (side-on cross-sectional views) of GDLs with engineered surface roughness, having irregularly shaped surface features, mixed regularly- and irregularly-shaped surface features, and hierarchical surface features.

FIG. 4 shows schematic illustrations (top-down views) of GDLs with engineered surface roughness wherein the surface features are periodically or randomly arranged.

FIG. 5A is a scanning confocal micrograph showing surface topography for an unmodified GDL with no engineered surface roughness or surface features.

FIG. 5B is a scanning confocal micrograph showing surface topography for a GDL with engineered surface roughness, having periodic surface features with an average depth of about 10 μm and an average lateral dimension of about 30 μm.

FIG. 6A shows a comparison of polarization curves—cell voltage (V) versus current density (A/cm²)—for a membrane electrode assembly containing the unmodified gas diffusion layer without engineered surface roughness (dashed line) shown in FIG. 5A and a membrane electrode assembly containing the gas diffusion layer with engineered surface roughness (solid line) shown in FIG. 5B.

FIG. 6B compares Tafel plots showing fuel cell performance normalized by catalyst loading for a membrane electrode assembly containing the unmodified gas diffusion layer without engineered surface roughness (dashed line) shown in FIG. 5A and a membrane electrode assembly containing the gas diffusion layer with engineered surface roughness (solid line) shown in FIG. 5B.

### DETAILED DESCRIPTION

Disclosed herein are gas diffusion layers (GDLs) for electrochemical devices which have increased surface area. A GDL with increased surface area may comprise a surface having engineered surface roughness for hosting catalysts and increasing the effective diffusivities of gas phase reactants in electrochemical devices (e.g., PEMFCs).

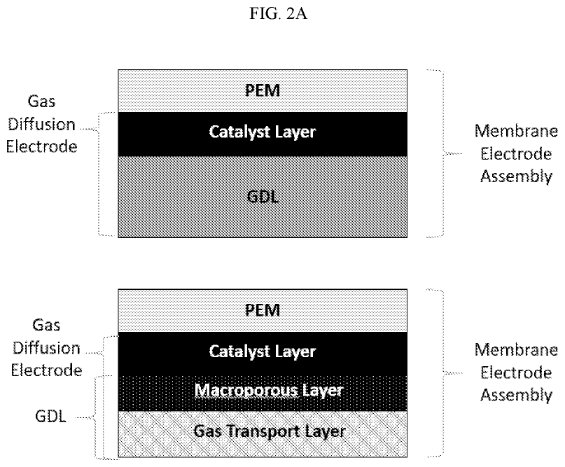

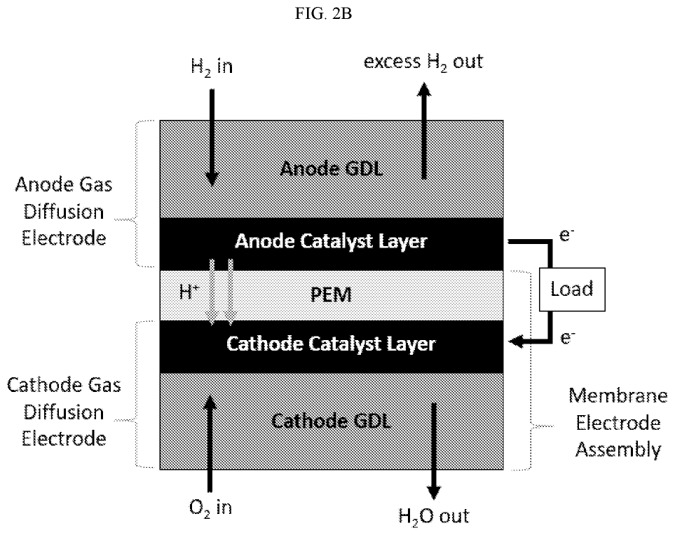

Referring to FIG. 2B, PEMFCs are constructed from membrane electrolyte assemblies (“MEAs”), which are in turn constructed from a proton-conducting polymer electrolyte membrane (“PEM”) in contact with a catalyst layer. MEAs according to the present disclosure may correspond to the cathode side and/or the anode side of an electrochemical device (e.g., fuel cell). The catalyst layer (anode or cathode) is interposed between a gas diffusion layer (“GDL”) and the PEM. The GDL layers permit gas-phase reactants (e.g., oxygen, hydrogen, etc.) to diffuse into the catalyst layers (e.g., of the anode and/or cathode) (e.g., platinum, etc.), where the anode or cathode cell reactions occur. Thus, the interface between the gas diffusion layer and the catalyst layer limits the rate at which gas phase reactants can enter the catalyst layer, participate in the cell reactions, and drive current flow through (and voltage across) the electrochemical device (e.g., fuel cell).

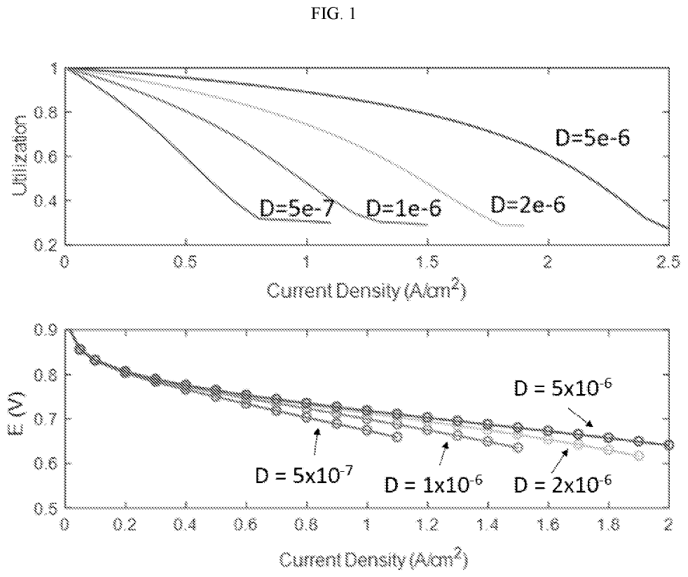

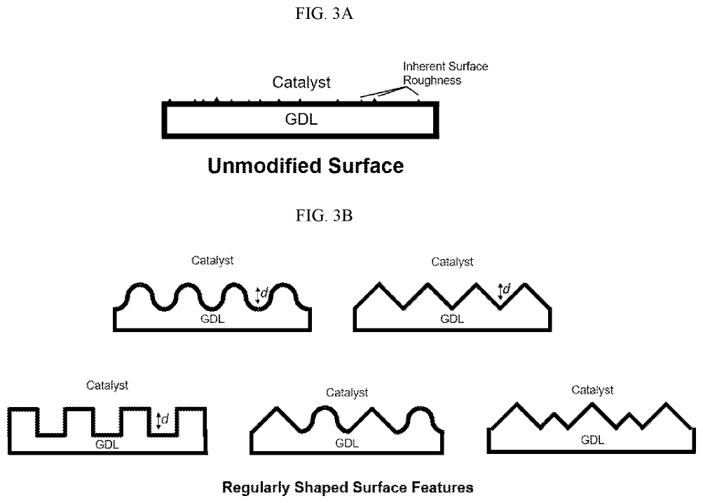

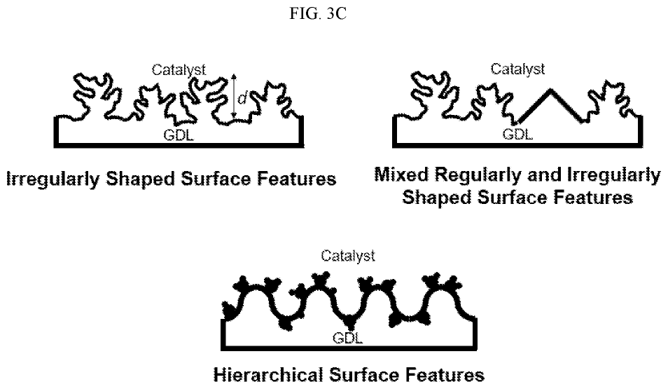

Referring to FIG. 3A, conventional GDLs have unmodified surfaces. Although conventional GDLs may have an inherent surface roughness (and are not strictly planar), they do not have engineered surface roughness. Thus, the surface area of the conventional GDL at the interface with a catalyst layer (see FIG. 2) and the effective diffusivity of gas-phase reactants into the catalyst layer are relatively low. To increase the surface area of the GDL at its interface with a catalyst layer, engineered surface roughness (or surface features) may be introduced to the GDL surface. Engineered surface roughness may be introduced to the GDL surface by any suitable method known in the art. For example, such engineered surface roughness or surface features may be introduced mechanically (e.g., by abrasion, molding, indentation, laser ablation, etc.), chemically (e.g., bottom-up: by a combination of lithography and PVD/CVD; or top-down: by a combination of lithography and chemical etching or dry etching), or by additive manufacturing processes (e.g., 3D printing). Although not being bound to or limited by any particular theory, when a GDL surface has engineered surface roughness, the surface area for a given cross-sectional area (or footprint) of the GDL surface increases (relative to an unmodified GDL surface with equal cross-sectional area or footprint), permitting a higher real area of contact between the GDL and the catalyst layer, a higher effective diffusivity of gas phase reactants (e.g., oxygen) into the catalyst layer, and improved performance of electrochemical devices (e.g., fuel cells) (see, e.g., FIG. 1).

As illustrated in FIGS. 3B and 3C, a first side or surface of the GDL having engineered surface roughness may comprise surface features with an average depth (d) or height which is the average peak-to-valley height for the surface features on the GDL surface. In some embodiments, the first side of the gas diffusion layer in contact with the catalyst layer comprises surface features having an average depth of between about 10 nm and about 1000 μm. In some embodiments, the surface features have an average depth of at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 150 nm, at least about 200 nm, at least about 250 nm, at least about 300 nm, at least about 350 nm, at least about 400 nm, at least about 450 nm, at least about 500 nm, at least about 550 nm, at least about 600 nm, at least about 650 nm, at least about 700 nm, at least about 750 nm, at least about 800 nm, at least about 850 nm, at least about 900 nm, at least about 950 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, at least about 950 μm, at least about 1000 μm, or greater, or any range or value thereinbetween.

In some embodiments, the surface features have an average depth or height of no greater than about 1000 μm, no greater than about 950 μm, no greater than about 900 μm, no greater than about 850 μm, no greater than about 800 μm, no greater than about 750 μm, no greater than about 700 μm, no greater than about 650 μm, no greater than about 600 μm, no greater than about 550 μm, no greater than about 500 μm, no greater than about 450 μm, no greater than about 400 μm, no greater than about 350 μm, no greater than about 300 μm, no greater than about 250 μm, no greater than about 200 μm, no greater than about 150 μm, no greater than about 100 μm, no greater than about 90 μm, no greater than about 80 μm, no greater than about 70 μm, no greater than about 60 μm, no greater than about 50 μm, no greater than about 40 μm, no greater than about 30 μm, no greater than about 20 μm, no greater than about 10 μm, no greater than about 9 μm, no greater than about 8 μm, no greater than about 7 μm, no greater than about 6 μm, no greater than about 5 μm, no greater than about 4 μm, no greater than about 3 μm, no greater than about 2 μm, no greater than about 1 μm, no greater than about 950 nm, no greater than about 900 nm, no greater than about 850 nm, no greater than about 800 nm, no greater than about 750 nm, no greater than about 700 nm, no greater than about 650 nm, no greater than about 600 nm, no greater than about 550 nm, no greater than about 500 nm, no greater than about 450 nm, no greater than about 400 nm, no greater than about 350 nm, no greater than about 300 nm, no greater than about 250 nm, no greater than about 200 nm, no greater than about 150 nm, no greater than about 100 nm, no greater than about 90 nm, no greater than about 80 nm, no greater than about 70 nm, no greater than about 60 nm, no greater than about 50 nm, no greater than about 40 nm, no greater than about 30 nm, no greater than about 20 nm, no greater than about 10 nm, or less, or any range or value thereinbetween.

In some embodiments, the surface features have an average depth or height of between about 10 nm and about 1000 μm, between about 50 nm and about 500 μm, between about 100 nm and about 100 μm, between about 500 nm and about 50 μm, between about 1 μm and about 10 μm, between about 10 nm and about 500 μm, between about 10 nm and about 100 μm, between about 10 nm and about 50 μm, between about 10 nm and about 10 μm, between about 10 nm and about 5 μm, between about 10 nm and about 1 μm, between about 10 nm and about 500 nm, between about 10 nm and about 100 nm, between about 10 nm and about 50 nm, between about 50 nm and about 1000 μm, between about 100 nm and about 1000 μm, between about 500 nm and about 1000 μm, between about 1 μm and about 1000 μm, between about 5 μm and about 1000 μm, between about 10 μm and about 1000 μm, between about 50 μm and about 1000 μm, between about 100 μm and about 1000 μm, between about 500 μm and about 1000 μm, between about 200 nm and about 200 μm, between about 200 nm and about 20 μm, between about 200 nm and about 2 μm, or any range or value thereinbetween.

In some embodiments, the first side of the gas diffusion layer in contact with the catalyst layer comprises surface features having at least one lateral dimension (e.g., major axis, minor axis, width, diameter, etc.) of between about 10 nm and about 1000 μm. In some embodiments, the surface features have at least one lateral dimension of at least about 10 nm, at least about 20 nm, at least about 30 nm, at least about 40 nm, at least about 50 nm, at least about 60 nm, at least about 70 nm, at least about 80 nm, at least about 90 nm, at least about 100 nm, at least about 150 nm, at least about 200 nm, at least about 250 nm, at least about 300 nm, at least about 350 nm, at least about 400 nm, at least about 450 nm, at least about 500 nm, at least about 550 nm, at least about 600 nm, at least about 650 nm, at least about 700 nm, at least about 750 nm, at least about 800 nm, at least about 850 nm, at least about 900 nm, at least about 950 nm, at least about 1 μm, at least about 2 μm, at least about 3 μm, at least about 4 μm, at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm, at least about 450 μm, at least about 500 μm, at least about 550 μm, at least about 600 μm, at least about 650 μm, at least about 700 μm, at least about 750 μm, at least about 800 μm, at least about 850 μm, at least about 900 μm, at least about 950 μm, at least about 1000 μm, or greater, or any range or value thereinbetween.

In some embodiments, the surface features have at least one lateral dimension of no greater than about 1000 μm, no greater than about 950 μm, no greater than about 900 μm, no greater than about 850 μm, no greater than about 800 μm, no greater than about 750 μm, no greater than about 700 μm, no greater than about 650 μm, no greater than about 600 μm, no greater than about 550 μm, no greater than about 500 μm, no greater than about 450 μm, no greater than about 400 μm, no greater than about 350 μm, no greater than about 300 μm, no greater than about 250 μm, no greater than about 200 μm, no greater than about 150 μm, no greater than about 100 μm, no greater than about 90 μm, no greater than about 80 μm, no greater than about 70 μm, no greater than about 60 μm, no greater than about 50 μm, no greater than about 40 μm, no greater than about 30 μm, no greater than about 20 μm, no greater than about 10 μm, no greater than about 9 μm, no greater than about 8 μm, no greater than about 7 μm, no greater than about 6 μm, no greater than about 5 μm, no greater than about 4 μm, no greater than about 3 μm, no greater than about 2 μm, no greater than about 1 μm, no greater than about 950 nm, no greater than about 900 nm, no greater than about 850 nm, no greater than about 800 nm, no greater than about 750 nm, no greater than about 700 nm, no greater than about 650 nm, no greater than about 600 nm, no greater than about 550 nm, no greater than about 500 nm, no greater than about 450 nm, no greater than about 400 nm, no greater than about 350 nm, no greater than about 300 nm, no greater than about 250 nm, no greater than about 200 nm, no greater than about 150 nm, no greater than about 100 nm, no greater than about 90 nm, no greater than about 80 nm, no greater than about 70 nm, no greater than about 60 nm, no greater than about 50 nm, no greater than about 40 nm, no greater than about 30 nm, no greater than about 20 nm, no greater than about 10 nm, or less, or any range or value thereinbetween.

In some embodiments, the surface features have at least one lateral dimension of between about 10 nm and about 1000 μm, between about 50 nm and about 500 μm, between about 100 nm and about 100 μm, between about 500 nm and about 50 μm, between about 1 μm and about 10 μm, between about 10 nm and about 500 μm, between about 10 nm and about 100 μm, between about 10 nm and about 50 μm, between about 10 nm and about 10 μm, between about 10 nm and about 5 μm, between about 10 nm and about 1 μm, between about 10 nm and about 500 nm, between about 10 nm and about 100 nm, between about 10 nm and about 50 nm, between about 50 nm and about 1000 μm, between about 100 nm and about 1000 μm, between about 500 nm and about 1000 μm, between about 1 nm and about 1000 μm, between about 5 nm and about 1000 μm, between about 10 nm and about 1000 μm, between about 50 nm and about 1000 μm, between about 100 nm and about 1000 μm, between about 500 nm and about 1000 μm, between about 200 nm and about 200 μm, between about 200 nm and about 20 μm, between about 200 nm and about 2 μm, or any range or value thereinbetween.

The areal density of surface features on a GDL surface with engineered surface roughness is not particularly limited. In some embodiments, surface features may constitute an area fraction of the GDL surface of at least about 1%, at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 99%, or greater, or any range or value thereinbetween.

In some embodiments, surface features may constitute an area fraction of the GDL surface of no greater than about 99%, no greater than about 95%, no greater than about 90%, no greater than about 85%, no greater than about 80%, no greater than about 75%, no greater than about 70%, no greater than about 65%, no greater than about 60%, no greater than about 55%, no greater than about 50%, no greater than about 45%, no greater than about 40%, no greater than about, 35%, no greater than about 30%, no greater than about 25%, no greater than about 20%, no greater than about 15%, no greater than about 10%, no greater than about 5%, or no greater than about 1%, or less, or any range or value thereinbetween.

In some embodiments, the GDL surface (or the interface between the gas diffusion layer and the catalyst layer) has an increased surface area relative to an unmodified GDL surface (or GDL-catalyst interface) without engineered surface roughness. In some embodiments the ratio of the surface area of the gas diffusion layer having engineered surface roughness (or the interface between the gas diffusion layer having engineered surface roughness and the catalyst layer), relative to an unmodified GDL (or the interface between an unmodified GDL without engineered surface roughness and a catalyst layer), is greater than about 1, greater than about 1.1, greater than about 1.2, greater than about 1.3, greater than about 1.4, greater than about 1.5, greater than about 1.6, greater than about 1.7, greater than about 1.8, greater than about 1.9, greater than about 2.0, greater than about 2.1, greater than about 2.2, greater than about 2.3, greater than about 2.4, greater than about 2.5, greater than about 2.6, greater than about 2.7, greater than about 2.8, greater than about 2.9, greater than about 3.0, greater than about 3.1, greater than about 3.2, greater than about 3.3, greater than about 3.4, greater than about 3.5, greater than about 3.6, greater than about 3.7, greater than about 3.8, greater than about 3.9, greater than about 4.0, greater than about 4.1, greater than about 4.2, greater than about 4.3, greater than about 4.4, greater than about 4.5, greater than about 4.6, greater than about 4.7, greater than about 4.8, greater than about 4.9, greater than about 5.0, greater than about 5.5, greater than about 6.0, greater than about 6.5, greater than about 7.0, greater than about 7.5, greater than about 8.0, greater than about 8.5, greater than about 9.0, greater than about 9.5, greater than about 10, greater than about 20, greater than about 30, greater than about 40, greater than about 50, greater than about 60, greater than about 70, greater than about 80, greater than about 90, greater than about 100, greater than about 200, greater than about 300, greater than about 400, greater than about 500, greater than about 600, greater than about 700, greater than about 800, greater than about 900, greater than about 1×10³, greater than about 2×10³, greater than about 5×10³, greater than about 1×10⁴, greater than about 2×10⁴, greater than about 5×10⁴, greater than about 1×10⁵, greater than about 5×10⁵, greater than about 1×10⁶, or greater, or any range or value thereinbetween.

Referring now to FIGS. 3A-C, the shapes of the surface features (either three-dimensional or two-dimensional cross-sectional shape) on a GDL with engineered surface roughness is not particularly limited. In some embodiments, a GDL surface engineered surface roughness comprises irregularly-shaped surface features (FIG. 3C). In some embodiments, a GDL surface engineered surface roughness comprises regularly-shaped surface features (FIG. 3B). Regular shapes of the surface features are not particularly limited and include, but are not limited to, hemispherical (e.g., domes), prismatic, cylindrical, pyramidal, conical, polyhedral or combinations thereof (FIG. 3B). In some embodiments, the surface features may comprise hierarchical structures (FIG. 3C) to further increase surface area relative to an unmodified GDL surface (FIG. 3A). In some embodiments, a GDL surface engineered surface roughness may comprise any combination of one or more irregularly shaped surface features, one or more regularly shaped surface features, or any combination thereof.

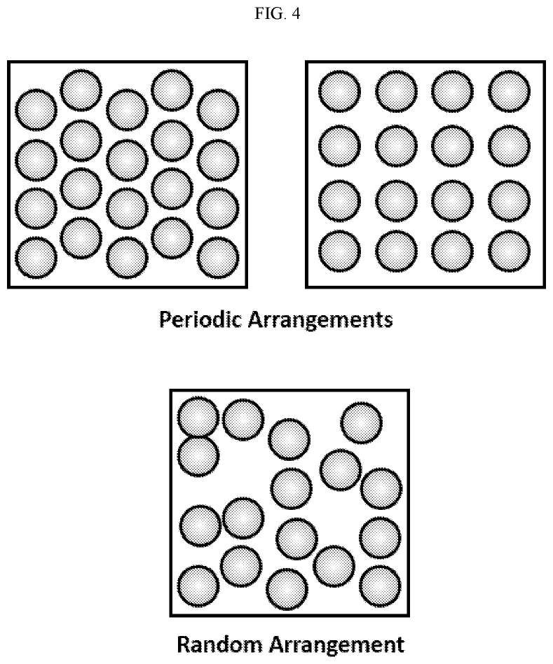

Referring now to FIG. 4, the arrangement of the surface features on the GDL surface with engineered surface roughness is not particularly limited. In some embodiments, the surface features are randomly arranged (FIG. 4, bottom), periodically arranged (FIG. 4, top), or a combination thereof. For instance, periodically arranged surface features may include arrangements in which the surface features are uniformly spaced along at least one dimension. In some embodiments, periodically arranged surface features may include arrangements in which the surface features are evenly spaced along two dimensions, such as in a two-dimensional unit cell. Such periodic arrangements may include, but are not limited to, hexagonal arrays and cubic arrays (FIG. 3, top). Such arrays may include uniform center-to-center or edge-to-edge distances between each surface feature and its nearest neighbors. The center-to-center or edge-to-edge distances are not particularly limited and may be, for example, any distance between about 1 nm and about 1000 μm. In some embodiments, a GDL surface having engineered surface roughness may comprise one or more groupings of random and/or periodic arrangements, and any embodiment of a GDL surface may comprise one type or more than one type of periodic arrangement of surface features.

Referring back to FIG. 1, a GDL includes a gas transport layer and, optionally, a microporous layer. In the absence of a microporous layer, the interface between the GDL and the catalyst layer is the interface between the gas transport layer and the catalyst layer. On the other hand, if a microporous layer is present, then the interface between the GDL and the catalyst layer is the interface between the microporous layer and the catalyst layer. When a microporous layer is present, then the side of the GDL in contact with the catalyst layer is disposed on the microporous layer.

A GDL according to the present disclosure is not particularly limited in terms of the material or materials constituting the GDL. As a non-limiting example, in some embodiments, the GDL comprises a carbon-based material, such as carbon nanotubes, carbon powder, carbon black, or a carbonaceous fibrous or woven layer, such as carbon cloth or carbon paper, which may be covered by a microporous layer. (See FIG. 2.) Further, a GDL according to the present disclosure may be coated by a hydrophobic material, such as PTFE.

Similarly, by way of non-limiting example, the catalyst layer according to the present disclosure is not particularly limited. In some embodiments, the catalyst comprises a platinum group metal (PGM), such as platinum (Pt), ruthenium (Ru), rhodium (Rh), palladium (Pd), osmium (Os), and iridium (Ir), as well as other metals, such as silver (Ag), gold (Au), or rhenium (Re), as well as an alloy or other multi-element material including one or more of the foregoing.

In another aspect, the present disclosure relates to a gas diffusion electrode comprising a GDL with increased surface area, as described above. Referring again to FIG. 2, in some embodiments, a gas diffusion electrode, comprises: (a) a gas diffusion layer; and (b) a catalyst layer in contact with the gas diffusion layer at an interface between the gas diffusion layer and the catalyst layer, wherein the surface of the GDL in contact with the catalyst layer has increased surface area. A GDL surface with increased surface area may comprise surface features with average depth, lateral dimensions, periodic and/or random arrangement, regular or irregular shape, areal density, and material composition, as described above.

In another aspect, the present disclosure relates to a membrane electrode assembly for a fuel cell. Referring again to FIG. 2, a membrane electrode assembly for a fuel cell may comprise: (a) a gas diffusion layer; (b) a polymer electrolyte membrane; and (c) a catalyst layer disposed between the gas diffusion layer and the polymer electrolyte membrane, wherein the gas diffusion layer comprises: (i) a first side in contact with the catalyst layer; and (ii) a second side, wherein the first side of the gas diffusion layer has increased surface area. A GDL surface with increased surface area may comprise surface features with average depth, lateral dimensions, periodic and/or random arrangement, regular or irregular shape, areal density, and material composition, as described above.

In another aspect, the present disclosure relates to a method of manufacturing a gas diffusion electrode for an electrochemical device, comprising: (a) providing a gas diffusion layer, wherein the gas diffusion layer comprises a first side having an increased surface area; and (b) contacting the first side of the gas diffusion layer with a catalyst layer. Referring back to FIG. 2, in some embodiments, the gas diffusion layer further comprises a gas transport layer and a macro-porous layer, wherein the macro-porous layer has a first side in contact with the gas transport layer and a second side; and the first side of the gas diffusion layer is the second side of the macro-porous layer. A GDL surface with increased surface area may comprise surface features with average depth, lateral dimensions, periodic and/or random arrangement, regular or irregular shape, areal density, and material composition, as described above.

Additionally, contacting the first side of the gas diffusion layer with a catalyst layer may comprise any suitable method known in the art for depositing or coating the catalyst layer onto the first side of the gas diffusion layer. Such methods may include, but are not limited to, physical vapor deposition, chemical vapor deposition, spin-casting, drop-casting, dip-coating, spray-coating, atomic layer deposition, sputtering, lamination, ink printing, powder coating, slot-die coating, doctor blade assembly, metering rod coating (Mayer bar coating), gravure coating, flexographic coating, or any combination thereof. Exemplary methods for catalyst deposition are described in PCT International Application No. PCT/US2019/063099 and U.S. application Ser. No. 16/791,650, the entireties of which are incorporated herein by reference.

In another aspect, the present disclosure relates to a method of manufacturing a membrane electrolyte assembly for an electrochemical device, comprising: (a) providing a gas diffusion layer, wherein the gas diffusion layer comprises a first side having an increased surface area; (b) contacting the first side of the gas diffusion layer with a catalyst layer, wherein the catalyst layer has a first side in contact with the gas diffusion layer and a second side; and (c) contacting the second side of the catalyst layer with a polymer electrolyte membrane.

Methods for contacting a GDL with a catalyst layer, or for contacting a catalyst layer with a PEM, may include any suitable method(s) for depositing, coating, or laminating a catalyst layer onto a GDL (or vice versa) or for depositing, coating, or laminating a catalyst layer onto a PEM (or vice versa). Such methods may include, but are not limited to, physical vapor deposition, chemical vapor deposition, spin-casting, drop-casting, dip-coating, spray-coating, atomic layer deposition, sputtering, lamination, ink printing, powder coating, slot-die coating, doctor blade assembly, metering rod coating (Mayer bar coating), gravure coating, flexographic coating, or any combination thereof. Exemplary methods for contacting a first side of a gas diffusion layer and/or contacting the second side of a catalyst layer with a polymer electrolyte membrane are described in PCT International Application No. PCT/US2019/063099 and U.S. application Ser. No. 16/791,650, the entireties of which are incorporated herein by reference.

Referring again to FIG. 2, in some embodiments, the gas diffusion layer further comprises a gas transport layer and a macro-porous layer having a first side in contact with the gas transport layer and a second side; and the first side of the gas diffusion layer is the second side of the macro-porous layer. A GDL surface with increased surface area for use in a membrane electrode assembly may comprise surface features with average depth, lateral dimensions, periodic and/or random arrangement, regular or irregular shape, areal density, and material composition, as described above.

Contacting the first side of the gas diffusion layer with a catalyst layer may comprise any suitable method known in the art for depositing or coating the catalyst layer onto the first side of the gas diffusion layer. Such methods may include, but are not limited to, physical vapor deposition, chemical vapor deposition, spin-casting, drop-casting, dip-coating, spray-coating, atomic layer deposition, sputtering, lamination, ink printing, powder coating, slot-die coating, doctor blade assembly, metering rod coating (Mayer bar coating), gravure coating, flexographic coating, or any combination thereof. Exemplary methods for contacting a first side of a gas diffusion layer with a catalyst layer are described in PCT International Application No. PCT/US2019/063099 and U.S. application Ser. No. 16/791,650, the entireties of which are incorporated herein by reference.

Additionally, contacting the second side of the catalyst layer with a polymer electrolyte membrane may comprise any suitable method known in the art for depositing or coating the polymer electrolyte membrane onto the catalyst layer, or for depositing or coating the catalyst layer onto the PEM. Such methods may include, but are not limited to, physical vapor deposition, chemical vapor deposition, spin-casting, drop-casting, dip-coating, spray-coating, atomic layer deposition, sputtering, lamination, ink printing, powder coating, slot-die coating, doctor blade assembly, metering rod coating (Mayer bar coating), gravure coating, flexographic coating, or any combination thereof. Exemplary methods for contacting the second side of a catalyst layer with a polymer electrolyte membrane are described in PCT International Application No. PCT/US2019/063099 and U.S. application Ser. No. 16/791,650, the entireties of which are incorporated herein by reference.

In another aspect, the present disclosure relates to a fuel cell comprising: (a) a gas diffusion layer; (b) a polymer electrolyte membrane; and (c) a catalyst layer disposed between the gas diffusion layer and the polymer electrolyte membrane, wherein the gas diffusion layer has an increased surface area. A GDL with increased surface area may comprise surface features with average depth, lateral dimensions, periodic and/or random arrangement, regular or irregular shape, areal density, and material composition, as described above.

### Definitions

As used herein, the term “increased surface area” refers to a surface area for a surface having engineered surface roughness that is greater than the surface area for unmodified surface without engineered surface roughness. For example, a surface of a gas diffusion layer with engineered surface roughness is greater than the surface area of a surface of an unmodified gas diffusion layer, even if both gas diffusion layers occupy the same footprint (area) when viewed from the top down. “Increased surface area” means that the ratio of the surface area of the surface with engineered surface roughness to the surface area of an unmodified surface occupying the same footprint is greater than about 1, greater than about 1.1, greater than about 1.2, greater than about 1.3, greater than about 1.4, greater than about 1.5, greater than about 1.6, greater than about 1.7, greater than about 1.8, greater than about 1.9, greater than about 2.0, greater than about 2.1, greater than about 2.2, greater than about 2.3, greater than about 2.4, greater than about 2.5, greater than about 2.6, greater than about 2.7, greater than about 2.8, greater than about 2.9, greater than about 3.0, greater than about 3.1, greater than about 3.2, greater than about 3.3, greater than about 3.4, greater than about 3.5, greater than about 3.6, greater than about 3.7, greater than about 3.8, greater than about 3.9, greater than about 4.0, greater than about 4.1, greater than about 4.2, greater than about 4.3, greater than about 4.4, greater than about 4.5, greater than about 4.6, greater than about 4.7, greater than about 4.8, greater than about 4.9, greater than about 5.0, greater than about 5.5, greater than about 6.0, greater than about 6.5, greater than about 7.0, greater than about 7.5, greater than about 8.0, greater than about 8.5, greater than about 9.0, greater than about 9.5, greater than about 10, greater than about 20, greater than about 30, greater than about 40, greater than about 50, greater than about 60, greater than about 70, greater than about 80, greater than about 90, greater than about 100, greater than about 200, greater than about 300, greater than about 400, greater than about 500, greater than about 600, greater than about 700, greater than about 800, greater than about 900, greater than about 1×10³, greater than about 2×10³, greater than about 5×10³, greater than about 1×10⁴, greater than about 2×10⁴, greater than about 5×10⁴, greater than about 1×10⁵, greater than about 5×10⁵, greater than about 1×10⁶, or greater, or any range or value thereinbetween.

As used herein, the term “engineered surface roughness” refers to surface roughness resulting from topographical features (e.g., “surface features” or “corrugations”) which differ in at least one of height, depth, lateral dimension, shape, or arrangement (periodic or random) from the natural or inherent nano-, micro-, or macro-scale surface texture or surface roughness. The natural or inherent surface roughness includes the nanoscale or microscale (local) surface roughness, as well as the macroscopic surface texture (e.g., waviness). For example, Sigracet 25BC, a commercially available GDL, has a microscale surface roughness (RMS) of approximately 2 μm as well as cracks that may be hundreds of micrometers deep and hundreds of micrometers long. Other commercially-available GDLs (e.g., carbon powders) may have similar natural or inherent nano-, micro-, or macro-scale roughness resulting from the material or layer formation process (e.g., during drying of carbon powder inks). “Engineered surface roughness” may be added to a commercially-available or pre-prepared GDL, or the GDL itself may be formed to possess engineered surface roughness (surface features that differ from the natural or inherent local and macroscale roughness).

As used herein, the singular terms “a,” “an,” and “the” may include plural referents unless the context clearly dictates otherwise. Thus, for example, reference to an object may include multiple objects unless the context clearly dictates otherwise.

As used herein, the terms “substantially,” “substantial,” “approximately,” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

In the description of some embodiments, an object “on” another object can encompass cases where the former object is directly on (e.g., in physical contact with) the latter object, as well as cases where one or more intervening objects are located between the former object and the latter object.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claim(s). In addition, many modifications may be made to adapt a particular situation, material, composition of matter, method, operation or operations, to the objective, spirit and scope of the disclosure. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

The present disclosure is not to be limited in terms of the particular embodiments described in this application, which are intended as single illustrations of individual aspects of the disclosure. All the various embodiments of the present disclosure will not be described herein. Many modifications and variations of the disclosure can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. While not explicitly defined below, such terms should be interpreted according to their common meaning.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 layers refers to groups having 1, 2, or 3 layers. Similarly, a group having 1-5 layers refers to groups having 1, 2, 3, 4, or 5 layers, and so forth.

It is to be understood that the present disclosure is not limited to particular uses, methods, reagents, compounds, compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

Unless the context indicates otherwise, it is specifically intended that the various features of the invention described herein can be used in any combination. Moreover, the disclosure also contemplates that in some embodiments, any feature or combination of features set forth herein can be excluded or omitted. To illustrate, if the specification states that an electrode assembly comprises components A, B and C, it is specifically intended that any of A, B or C, or a combination thereof, can be omitted and disclaimed singularly or in any combination.

Unless explicitly indicated otherwise, all specified embodiments, features, and terms intend to include both the recited embodiment, feature, or term and biological equivalents thereof.

All patents, patent applications, provisional applications, and publications referred to or cited herein are incorporated by reference in their entirety, including all figures and tables, to the extent they are not inconsistent with the explicit teachings of this specification.

### EXAMPLES

### Example 1: Comparison of Fuel Cell Performance for GDLs Having Engineered Surface Roughness and GDLs Having Unmodified Surfaces

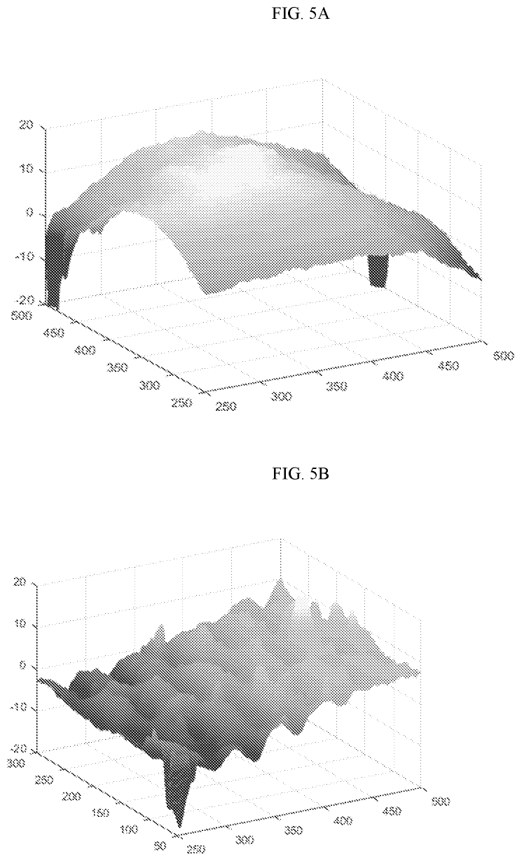

To investigate the effect of engineered GDL surface roughness on MEA performance, MEAs containing GDLs with increased surface area were prepared, and their performance was compared to that of MEAs containing unmodified GDLs. Engineered surface roughness was introduced to a commercially available GDL (Sigracet 25BC) using a dry etching procedure. Surface morphologies for a GDL with increased surface roughness (FIG. 5B) and an unmodified GDL (FIG. 5A) were compared using a Keyence VK-X Series 3D Scanning Confocal Microscope. FIGS. 5A-B (units in μm) show that the dry etching procedure produced a GDL surface with engineered surface roughness with periodically-arranged features having an average depth of about 10 μm and an average lateral dimension of about 30 μm, while the unmodified GDL was smooth by comparison, showing only its natural or inherent surface roughness.

Following the surface treatment procedure, a catalyst layer (0.1 mg/cm² Pt/C; 46 wt. % Pt) was applied to each GDL using a filtration method to produce gas diffusion electrodes (GDEs). Each GDE was then pressed against a catalyst-coated membrane (CCM with 0.1 mg/cm² Pt/C on the anode side), along with the anode GDL to form an MEA for performance testing.

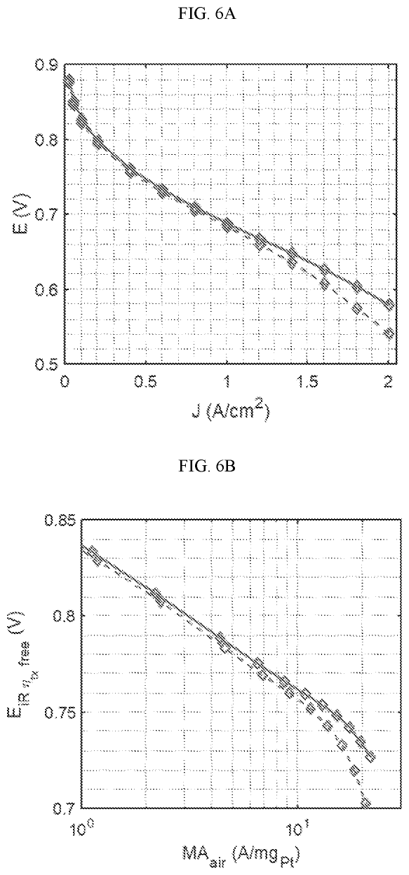

MEA performance testing was conducted using a Scribner 840 fuel cell testing system with a Greenlight 50 cm² research cell fixture. Cells were maintained at 80° C., 100% RH, and 150 kPa absolute backpressure. Polarization curves (FIG. 6A) were acquired in 5000 sccm house air with current held for 3 min, consistent with the U.S. Department of Energy Fuel Cell Technology Office 2016 protocol. The cell resistance was taken from the high-frequency x-intercept of an electrochemical impedance Nyquist plot measured at 0.25 A in oxygen. The limiting current was recorded as the average current density during the brief 0.3 V hold across all measurements. In post-processing, the limiting current was used to calculate the total 02 transport resistance and concentration voltage losses as a function of current density. Resistance correction is applied to compare the cathode performance with a Tafel plot (FIG. 6B).

As shown in FIGS. 6A and 6B, the increased surface area of the GDL with engineered surface roughness enhances performance of the fuel cell device. FIG. 6A compares cell voltage versus current density for the unmodified GDL (dashed line), shown in FIG. 5A, and the GDL with increased surface area (solid line), shown in FIG. 5B. The polarization curves in FIG. 6A show increased cell voltage for the device with a GDL having increased surface area, which becomes more pronounced at the high current density region (e.g., above 1 A/cm²). FIG. 6B shows Tafel plots of cell performance normalized by catalyst loading, which also reveals increased cell voltage for a device with a GDL having engineered surface roughness (solid line) compared to a similar device with an unmodified GDL surface (dashed line), which becomes more pronounced in the high current density region.

While not being bound to or limited by any particular theory, as shown in these results, it is believed that a GDL with increased surface area increases the surface area at the catalyst-GDL interface available for a gas-phase reactant (e.g., oxygen) to diffuse into the catalyst layer of a fuel cell, thereby increasing the effective diffusivity of the gas-phase reactant and enhancing the cell voltage and catalyst utilization, particularly in the high-current-density region.

Other embodiments are set forth in the following claims.

1. A gas diffusion layer for an electrochemical device, comprising:
(a) a first side in contact with a catalyst layer; and
(b) a second side;
wherein the first side in contact with the catalyst layer has increased surface area.

2. The gas diffusion layer of claim 1, wherein the first side in contact with the catalyst layer comprises surface features having an average depth of between about 10 nm and about 1000 μm.

3. The gas diffusion layer of claim 1, wherein the surface features have at least one lateral dimension between about 10 nm and about 1000 μm.

4. The gas diffusion layer of claim 1, comprising surface features that are regularly shaped.

5. The gas diffusion layer of claim 1, comprising surface features that are irregularly shaped.

6. The gas diffusion layer of claim 1, comprising surface features that are randomly arranged.

7. The gas diffusion layer of claim 1, comprising surface features that are periodically arranged.

8. The gas diffusion layer of claim 1, further comprising a microporous layer, wherein the first side in contact with the catalyst layer is disposed on the microporous layer.

9. A gas diffusion electrode, comprising:
(a) a gas diffusion layer; and
(b) a catalyst layer in contact with the gas diffusion layer at an interface between the gas diffusion layer and the catalyst layer,
wherein the interface between the gas diffusion layer and the catalyst layer has an increased surface area.

10. The gas diffusion electrode of claim 9, wherein the interface between the gas diffusion layer and the catalyst layer comprises surface features that have an average depth of between about 10 nm and about 1000 μm.

11. The gas diffusion electrode of claim 9, wherein the surface features have at least one lateral dimension between about 10 nm and about 1000 μm.

12. The gas diffusion electrode of claim 9, comprising surface features that are regularly shaped.

13. The gas diffusion electrode of claim 9, comprising surface features that are irregularly shaped.

14. The gas diffusion electrode of claim 9, comprising surface features that are randomly arranged.

15. The gas diffusion electrode of claim 9, comprising surface features that are periodically arranged.

16. The gas diffusion electrode of claim 9, wherein the gas diffusion layer further comprises a microporous layer, wherein the side of the gas diffusion layer in contact with the catalyst layer is disposed on the microporous layer.

17. A membrane electrode assembly for a fuel cell, comprising:
(a) a gas diffusion layer;
(b) a polymer electrolyte membrane; and
(c) a catalyst layer disposed between the gas diffusion layer and the polymer electrolyte membrane, wherein:
the gas diffusion layer comprises:
(i) a first side in contact with the catalyst layer; and
(ii) a second side,
wherein the first side of the gas diffusion layer has increased surface area.

18. The membrane electrode assembly of claim 17, wherein the first side of the gas diffusion layer in contact with the catalyst layer comprises surface features having an average depth of between about 10 nm and about 1000 μm.

19. The membrane electrode assembly of claim 17, wherein the first side of the gas diffusion layer in contact with the catalyst layer comprises surface features having at least one lateral dimension of between about 10 nm and about 1000 μm.

20. The membrane electrode assembly of claim 17, wherein the gas diffusion layer comprises surface features that are regularly shaped.

21. The membrane electrode assembly of claim 17, wherein the gas diffusion layer comprises surface features that are irregularly shaped.

22. The membrane electrode assembly of claim 17, wherein the gas diffusion layer comprises surface features that are randomly arranged.

23. The membrane electrode assembly of claim 17, wherein the gas diffusion layer comprises surface features that are periodically arranged.

24. The membrane electrode assembly of claim 17, wherein the gas diffusion layer comprises a microporous layer, wherein the first side in contact with the catalyst layer is disposed on the microporous layer.

25. A fuel cell comprising the membrane electrode assembly of claim 17.

26. A fuel cell comprising:
(a) a gas diffusion layer;
(b) a polymer electrolyte membrane; and
(c) a catalyst layer disposed between the gas diffusion layer and the polymer electrolyte membrane, wherein:
the gas diffusion layer has an increased surface area.

27. A method of manufacturing a gas diffusion electrode for an electrochemical device, comprising:
(a) providing a gas diffusion layer, wherein the gas diffusion layer comprises a first side having an increased surface area; and
(b) contacting the first side of the gas diffusion layer with a catalyst layer.

28. The method of claim 27, wherein:
the gas diffusion layer further comprises a gas transport layer and a macro-porous layer having a first side in contact with the gas transport layer and a second side; and
the first side of the gas diffusion layer is the second side of the macro-porous layer.

29. A method of manufacturing a membrane electrolyte assembly for an electrochemical device, comprising:
(a) providing a gas diffusion layer, wherein the gas diffusion layer comprises a first side having an increased surface area;
(b) contacting the first side of the gas diffusion layer with a catalyst layer, wherein the catalyst layer has a first side in contact with the gas diffusion layer and a second side; and
(c) contacting the second side of the catalyst layer with a polymer electrolyte membrane.

30. The method of claim 29, wherein:
the gas diffusion layer further comprises a gas transport layer and a macro-porous layer having a first side in contact with the gas transport layer and a second side; and
the first side of the gas diffusion layer is the second side of the macro-porous layer.
